(19) United States
(12) Patent Application Publication
(10) Pub. No.: US 2002/0042748 A1
(43) Pub. Date: Apr. 11, 2002

(54) Sale device with a function to authenticate a purchaser and method thereof

(76) Inventors: Tetsuo Nakata, Aomori (JP); Mitsumasa Nagase, Aomori (JP); Takashi Yugami, Aomori (JP); Atsushi Akagi, Aomori (JP); Osamu Kimura, Aomori (JP)

Correspondence Address: STAAS & HALSEY LLP, 700 11TH STREET, NW, SUITE 500, WASHINGTON, DC, 20001, US

(21) Appl. No.: 09/812,551

(22) Filed: Mar. 21, 2001

(30) Foreign Application Priority Data
Oct. 6, 2000 (JP) 2000-308318

(51) Int. Cl. G06F 17/60

(52) U.S. Cl. 705/26; 705/50

(57) ABSTRACT

A sale device is connected to the terminals of a purchaser and a seller, respectively, via a network. The sale device comprises a work information acquisition unit, an information provision unit, a payment confirmation unit and a purchase information acquisition unit. The work information acquisition unit receives sale consignment per units of rights of a literary work from a seller via a network. The purchase information acquisition unit sells a literary work to a purchaser per units of rights via the network and the unit obtains information about the purchaser at the time of purchase. When the payment conformation unit confirms the payment of a purchase price, the information provision unit provides the information about a purchaser via the network. Any person can read this provided information via the network.

In this way, the intentional copyright infringement of a person that sells literary works can be suppressed.

### BACKGROUND OF THE INVENTION

1. Field of the Invention

The present invention relates to the sale of commodities, and in particular relates to a system for selling literary works, such as novels, paintings, software programs, etc.

2. Description of the Related Art

Lately, thanks to the development of a telecommunications technology, a variety of commodities have been traded via a network. Commodities to be traded include a variety of literary works, such as software programs for games, computer graphics, etc., novels, paintings, photographs, etc., in addition to conventional commodities, such as hardware, etc.

Each of these literary works has a copyright infringement problem due to illegal copying. This problem is serious in the case of an electronic literary work. In the case of an electronic literary work, an encryption technology using a private key, etc., is adopted in order to solve this problem.

However, in the case of an electronic literary work, along with the development of a protective technology, such as a conventional encryption, etc., a destructive technology for nullifying such a protective technology is also developed. Therefore, there is a problem that the extinction of copyright infringements cannot be expected in the future.

A general user often has no sufficient knowledge of a copyright and does not well understand rights allowed to the user regardless of the type of a literary work. Therefore, there is also a problem that a user unintentionally infringes a copyright when the user uses a purchased commodity.

### SUMMARY OF THE INVENTION

In view of the problems described above, it is an object of the present invention to suppress the intentional copyright infringement of a person that sells literary works and to prevent a purchaser that does not properly understand a copyright from infringing on a copyright while selling literary works.

The present invention has a high utility value in particular when a literary work is sold.

According to the one aspect of the present invention, a sale device for selling literary works is connected to a network, and it comprises a purchase information acquisition unit for obtaining information about the purchaser of a literary work and an information provision unit for providing information about a purchaser via the network.

If information about a purchaser is provided via a network and a seller reads the information, the sale amount of a literary work can be obtained and the purchaser can also be confirmed. As a result, a purchaser and a copyright infringer can be fairly easily distinguished.

A sale device can verify that a purchaser is the legal holder of a right. Therefore, even if a purchaser is suspected of an infringer, the purchaser can fairly easily clear the suspicion.

Further, this information about a purchaser can be publicized. By indicating that a purchaser has legally purchased a literary work, the moral of an infringer to be can be influenced. In this way, intentional copyright infringements can be suppressed.

In the configuration described above, the purchase information acquisition unit can also be designed to sell a literary work per units of rights based on a copyright and to obtain information about a purchaser for each sold right. In this way, a right to be sold by a seller or a right to be purchased by a purchaser can be easily distinguished.

The configuration described above can further comprise a purchased-right information provision unit for providing information about a purchaser for each right. Even if a purchaser does not well understand the copyright law, by reading information provided for each right, the purchaser can confirm a purchased right. Therefore, unintentional copyright infringements can be prevented.

The configuration described above can further comprise a work information acquisition unit for notifying the seller of a literary work of rights based on a copyright corresponding to the type of the literary work and obtaining information about a right to be sold, out of the notified rights. By notifying a seller of rights to be sold corresponding to the type of a work and enabling a seller to select a right to be sold, out of the notified rights, the seller can be prevented from selling a right that cannot be sold by mistake.

Also, the configuration described above can further comprise a payment confirmation unit for confirming the payment of a purchase price, and the information provision unit can provide information about a purchaser after the payment confirmation unit confirms the payment of the purchase price.

According to another aspect of the present invention, a method for selling a literary work comprises the steps of selling a literary work and providing information about the purchaser of a literary work via a network. In this way, the problems described above can also be solved.

The problems described above can also be solved by enabling a computer to read a program for the computer to implement the same function as that implemented by each of the configurations, from a computer-readable storage medium that stores the program, and to execute the program.

### BRIEF DESCRIPTIONS OF THE DRAWINGS

The features and advantages of the present invention will be more clearly appreciated from the following descriptions taken in conjunction with the accompanying drawings, in which the same elements are denoted by the same reference numbers and in which:

FIG. 1 shows the configuration of the sale system of the present invention;

FIG. 2 shows rights based on a copyright;

FIG. 3 shows an example of a data structure of a work type table;

FIG. 4 shows an example of a data structure of a right table;

FIG. 5 shows an example of a data structure of an author master;

FIG. 6 shows an example of a data structure of a work master;

FIG. 7 shows an example of a data structure of a purchaser information file;

FIG. 8 shows an example of a data structure of a bank master;

FIG. 9 shows an example of a data structure of a branch master;

FIG. 10 shows data transition;

FIG. 11 is a flowchart showing the basic process flow of the sale device (No.1);

FIG. 12 is a flowchart showing the basic process flow of the sale device (No.2);

FIG. 13 is a flowchart showing the basic process flow of the sale device (No.3);

FIG. 14 shows an example of a work type selection screen;

FIG. 15 shows an example of a browsing/registration selection screen;

FIG. 16 shows an example of a work exhibition screen;

FIG. 17 shows an example of a purchased-right information screen;

FIG. 18 shows an example of a purchase screen.

FIG. 19 shows an example of a work registration screen;

FIG. 20 shows an example of a detailed work information screen;

FIG. 21 shows an example of a detailed author information screen;

FIG. 22 is a flowchart showing a process of displaying works and rights to be sold;

FIG. 23 is a flowchart showing a process of providing a purchased-right information;

FIG. 24 is a flowchart showing a process of obtaining purchase information;

FIG. 25 is a flowchart showing a process performed when the input of work information is designated;

FIG. 26 is a flowchart showing a process of obtaining work information;

FIG. 27 is a flowchart showing a process of confirming payment;

FIG. 28 shows the configuration of an information processing device;

FIG. 29 shows a computer-readable storage medium, a transmission medium and a transmission signal.

### DESCRIPTION OF THE PREFERRED EMBODIMENTS

The preferred embodiments of the present invention are described below with reference to the drawings. The same reference number is attached to the same unit and the description is omitted.

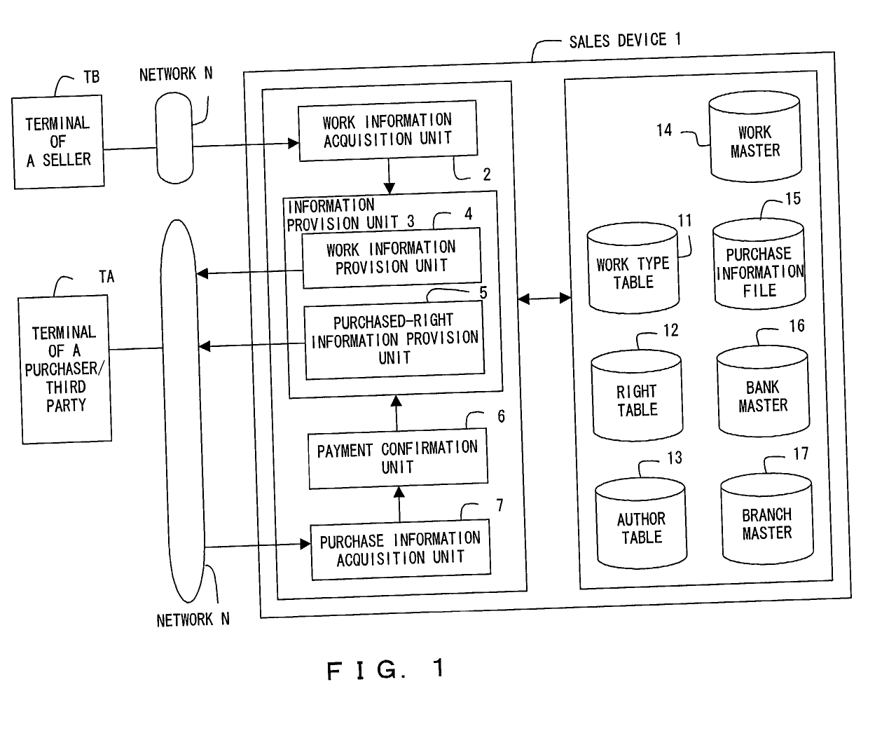

FIG. 1 shows the configuration of a sale system with a function to authenticate a purchaser, in the preferred embodiment of the present invention. As shown in FIG. 1, a purchaser/third party terminal TA, a work seller terminal TB (in many cases, a seller equals an author) and a sale device 1 are connected to one another via a network N. The network N can be one network or a combination of a plurality of networks. For the network N, aWAN (Wide Area Network) such as the Internet, a telephone network, a wireless network, and a LAN (Local Area Network), etc., for example, can be used. A purchaser, third party and a seller transmit/receive information to/from each other using terminals TA and TB, respectively. For the terminals TA and TB, for example, a desktop terminal and a portable information terminal, such as a cellular phone, a portable computer, etc., are used.

The sale device 1 verifies that a purchaser has purchased the right of a registered work by providing purchased-right information, which is information about a right purchased by a purchaser, via the network N while selling the work. The sale device 1 comprises a work information acquisition unit 2, an information provision unit 3, a payment confirmation unit 6, a purchase information acquisition unit 7, a work type table 11, a right table 12, an author master 13, a work master 14, a purchase information file 15, a bank master 16 and a branch master 17.

The work information acquisition unit 2 obtains work information, which is information about a work, from the seller of the work. Work information includes information about both a work and the rights to be sold of the work based on a copyright. The work information acquisition unit 2 stores the obtained work information in the work master 14. The work information acquisition unit 2 can obtain information about rights based on a copyright, that is, rights can be sold corresponding to a work type by referring to both the work type table 11 and right table 12 using the type of a work, the work information of which a seller is going to register, and can notify the seller of the obtained information. As a result, the seller can be prevented from selling rights that cannot be sold, by mistake.

The information provision unit 3 comprises a work information provision unit 4 and a purchased-right information provision unit 5. The work information provision unit 4 provides both author information, which is information about an author, and the work information obtained by the work information acquisition unit 2 via the network N. The purchased-right information provision unit 5 provides purchased-right information, which is information about the rights of each work purchased by a purchaser based on purchase information obtained by the purchase information acquisition unit 7 described later.

The payment confirmation 6 confirms that a purchaser has paid the purchase price of a work (the rights of a work) to a prescribed account. If the payment confirmation unit 6 confirms the payment, the purchased-right information provision unit 5 provides purchased-right information corresponding to the purchaser that has paid. The purchase information acquisition unit 7 obtains purchase information, which is information about the purchase of a work, from the purchaser to be of the work and stores the information in the purchase information file 15. Purchase information includes both information about the purchaser and information about the rights of a work to be purchased.

Information provided by the information provision unit 3 can be browsed by any person via the network N. In this way, a seller can obtain the purchase amount of a literary work and can also confirm both a purchaser and purchased rights by browsing the purchased-right information. Therefore, a seller can fairly easily distinguish a purchaser from the infringer of a copyright.

By publicizing purchased-right information, the sale device 1 can verify that a purchaser is the legal holder of a right. Therefore, if the purchaser is suspected of an infringer, the purchaser can fairly easily clear his/her suspicion. By browsing the purchased-right information, the purchaser can easily confirm rights that he/she has purchased. Therefore, even if a purchaser does not well understand the copyright law, the purchaser can be prevented from unintentionally infringing a copyright.

By publicizing the purchased-right information, it is indicated that a purchaser has legally purchased a right by paying the purchase price and the moral of an infringer to be is influenced. Therefore, intentional copyright infringements can be suppressed.

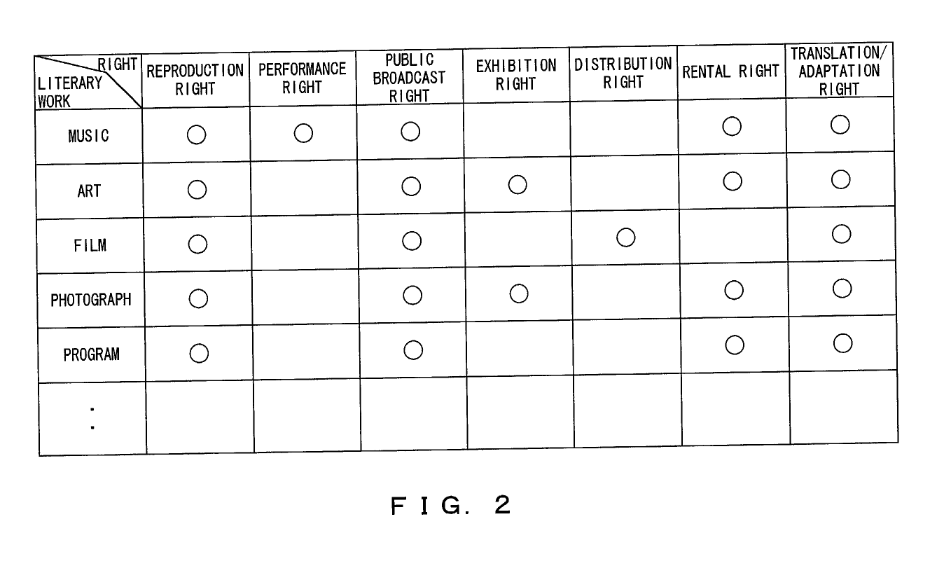

Rights based on a copyright are described below with reference to FIG. 2. FIG. 2 shows an example of rights based on a copyright corresponding to a type of a literary work. FIG. 2 is based on Japan Copyright Law effective as of September 2000. For example, if a type of a literary work is music, the right based on the copyright includes a reproduction right, a performance right, a public broadcast right, a rental right and a translation/adaptation right. The rights based on a copyright for each other type of a literary work are marked ◯. In this way, rights based on a copyright vary depending on the type of a literary work.

The data structure of each table, file, etc., is described with reference to the drawings. In each drawing, data items to be stored (data name), the attribute of each piece of data, data length and specific data to be stored are exemplified.

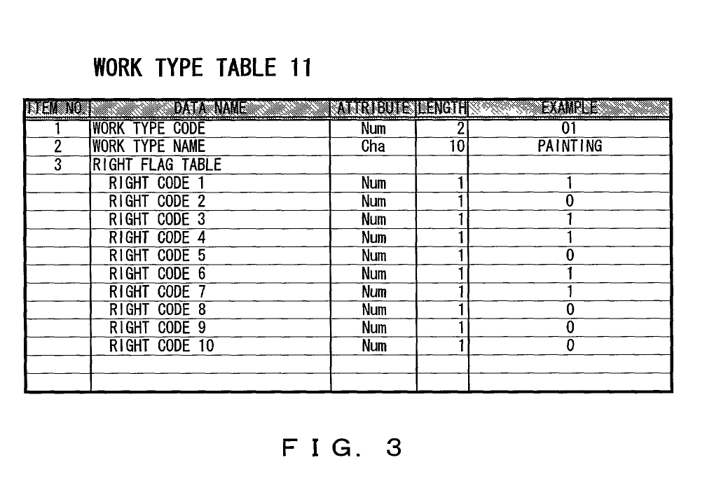

FIG. 3 shows an example of a data structure of a work type table. The work type table 11 stores work type information, which is information about rights based on a copyright corresponding to the type of a work (literary work) . Work type information includes a work type code for identifying the type of a work, the type name of a work and a right flag table. The right flag table indicates rights based on a copyright. If the flag is 1, it indicates that a corresponding right exists. If the flag is 0, it indicates that corresponding right does not exist.

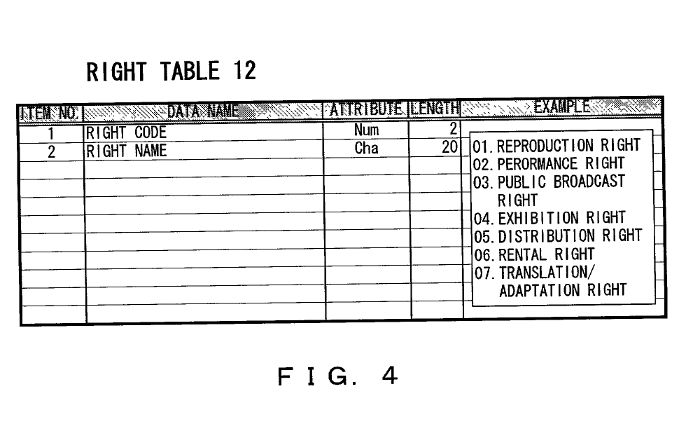

A right indicated by each right code shown in FIG. 3 is defined in the right table 12 shown in FIG. 4. In FIG. 3, flags are hoisted for right codes 1, 3, 4, 6 and 7. In this way, it is judged that a reproduction right (01), a public broadcast right (03), an exhibition right (04), a rental right (06) and a translation/adaptation right (07) exist, based on a legend in the right table. Specifically, in the examples shown in FIGS. 3 and 4 it is indicated that “in the case of painting, a reproduction right, a public broadcast right, an exhibition right, a rental right and a translation /adaptation right are based on a copyright”.

In this way, the contents shown in FIG. 2 are stored as data using both the work type table 11 and right table 12 shown in FIGS. 3 and 4, respectively. Both the work type table 11 and the right table 12 are stored in advance in the database of the sale device 1 and are updated from time to time, as requested, for example, when the copyright law is revised.

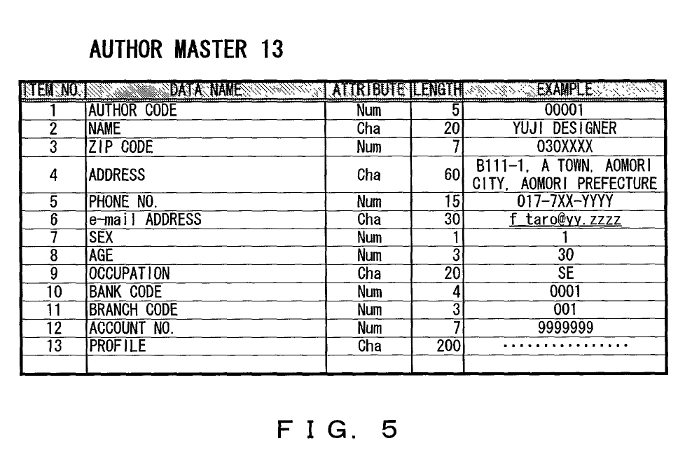

FIG. 5 shows an example of a data structure of the author master 13. The author master 13 stores author information, which is information about the author of a work. Author information includes an author code for identifying an author, the personal information of an author, information about an account to be used to pay a purchase price, the self introduction of an author, etc. For the personal information, for example, a name, a zip code, an address, a phone number, an e-mail address, sex, age and occupation can be used. For the information about an account, for example, a bank code for identifying a financial institute (bank, etc.), a branch code for identifying a branch and an account number for identifying an account can be used. Information stored in the author master 13 is based on an input by a seller (author). The definitions of the bank code and branch code are stored in the bank master 16 and branch master 17, respectively. Although in this preferred embodiment it is described that author information is registered in advance, it can also be configured so that the work information acquisition unit 2 can obtain author information too from time to time.

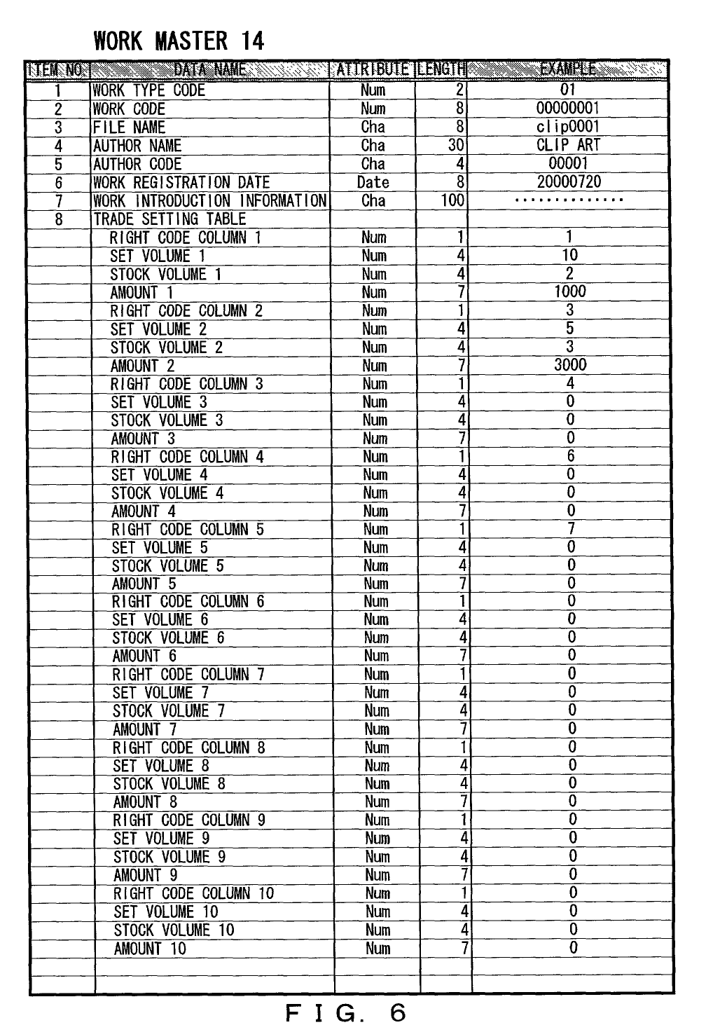

FIG. 6 shows an example of a data structure of the work master 14. The work master 14 stores work information, which is information about a work. Work information includes a work type code for identifying the type of a work, a work code for identifying a work, the data file name of a work in the case of electronic work, a data file name for indicating a work sample in the case of painting, etc., a work name, a work registration date for indicating a time when a work is registered in the sale device 1, work introduction information, which is information for introducing a work and a trade setting table for indicating rights, which is set in the trade of the work. The trade setting table stores rights to be sold by a seller, the number of rights set to be sold (set volume), stock volume and a sale amount (set amount) for each right based on a copyright corresponding to a type of a work shown in FIGS. 3 and 4.

In the example of a trade setting table shown in FIG. 6, it is indicated that in the columns 1 for a right code, a set volume, a stock volume and a set amount (sale price), 1, 10, 2 and 1,000 are stored, respectively. This means that a right corresponding to right code 1, namely a reproduction right, is set to be sold and a set volume, a stock volume and a set amount (sale price) of the right are 10, 2 and 1,000 yen, respectively. Also, it is indicated that in the columns 3 to 5 for right code, 4, 6 and 7 are stored, and in the columns 3 to 5 for a set volume, 0 (zeros) are stored. This means that the rights corresponding to right codes 4, 6 and 7, namely an exhibition right, a rental right and a translation/adaptation right can be sold, but their set volume are 0 (zeros) . An author of a work does not want to sell these rights. As a result, both a stock volume and a set amount are also 0 (zeros) as shown in columns 2 to 5 for a stock volume and a set amount in FIG. 6. Other information than a stock volume is stored by the work information acquisition unit 2 based on information inputted by a seller. A stock volume is updated by the purchase information acquisition unit 4 every time a work is purchased.

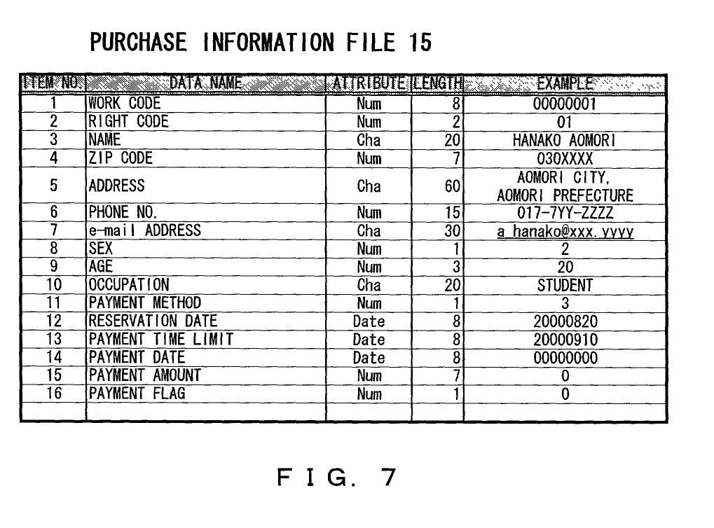

FIG. 7 shows an example of a data structure of the purchase information file 15. The purchase information file 15 stores purchase information, which is information about purchase. Purchase information includes a work code for a purchased work, a right code for purchased right, personal information of a purchaser, a payment method, a purchase reservation date, a payment time limit, a payment date, which is a time when payment is confirmed, a payment amount and a payment flag for indicating that payment is made. Personal information includes the same items as those of an author, stored in the author master 13.

The work code, right code, personal information of a purchaser, payment method and reservation date are based on an input by a purchaser. The payment time limit is stored by the purchase information acquisition unit 7 when purchase information is obtained. The payment date, payment amount and payment flag are stored by the payment confirmation unit 6 when payment is confirmed.

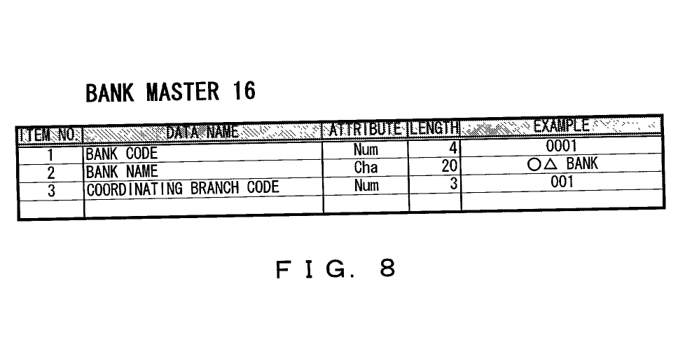

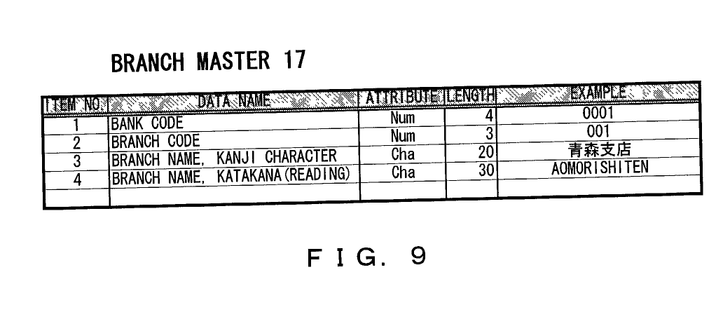

FIGS. 8 and 9 show examples of data structure of the bank master and branch master, respectively. The bank master 16 and branch master 17 define the bank and branch, respectively, indicated by each code. Both the bank master 16 and branch master 17 are stored in advance in the database of the sale device 1 and are updated from time to time, as requested.

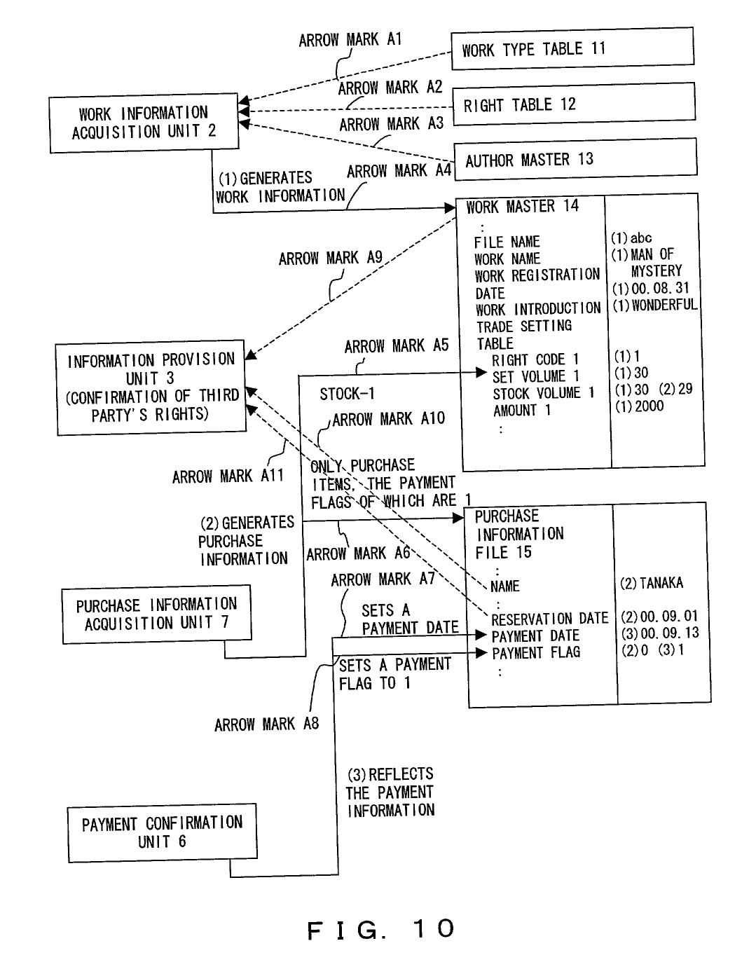

The data transition in this system is described below with reference to FIG. 10. In FIG. 10, the acquisition of data from the database is indicated by a dashed arrow. Both the storage of data in the database and the update of data stored in the database is indicated by a solid arrows.

First, the work information acquisition unit 2 generates author information based on the input of a seller and stores the information in the author master 13, which is not shown in FIG. 10. When obtaining work information from a seller, the work information acquisition unit 2 specifies a work type based on the input of a seller, obtains work type information corresponding to the specified work type from the work type table 11 (arrow mark Al) and obtains the definition of a right code from the right table 12 (arrow mark A2). The work information acquisition unit 2 instructs a seller to input an author code and obtains an author name by referring to the author master 13 using the author code (arrow mark A3). Based on both the obtained work type information and the definition of the right code, the work information acquisition unit 2 indicates rights based on a copyright for the specified work type and also instructs the seller to input work information. When instructing, the work information acquisition unit 2 outputs the obtained author name on the screen of the seller's terminal. The seller confirms the author name and inputs the work information of a work to be sold, the rights to be sold, the set volume and the set amount (sale price). The work information acquisition unit 2 stores the obtained work information in the work master 14 (arrow mark A4).

If a purchaser designates the purchase process of a work to be sold in the sale device 1, the purchase information acquisition unit 7 decrements by one the stock volume of the purchased right included in the work information corresponding to the purchased work by referring to the work master 14 using the work code of the purchased work (arrow mark A5) . Furthermore, the purchase information acquisition unit 7 obtains purchase information from the purchaser and stores the information in the purchase information file 15.

The payment confirmation unit 6 checks whether payment is made to a prescribed account. If the payment is confirmed, the payment confirmation unit 6 obtains purchase information corresponding a payer by referring to the purchase information file 15 using information included in the payment information for reporting payment, reported by a financial institute, such as the name of a payer and a phone number, stores a payment date in the purchase information (arrow mark A7) and sets the payment flag on (1 indicates on) (arrow mark A8). The paid purchase price is transmitted to an author based on information about the account of the author included in author information stored in the author master 13.

If an arbitrary person designates the browsing of work information and/or purchased-right information, the work information provision unit 4 of the information provision unit 3 obtains work information corresponding to a selected work by referring to the work master 14 using the work code of the work selected by the arbitrary person and provides the arbitrary person with the information (arrow mark 9). The purchased-right information provision unit 5 searches for purchase information about both the selected work and right by referring to the purchase information file 15 using both the work code and right code of the work and right, respectively, selected by the arbitrary person and obtains both the name of a purchaser and reservation date (purchase date) from purchase information, the payment flag of which is set on, out of a plurality of pieces of purchase information obtained as a result of the search (arrow marks A10 and A11). The purchased-right information provision unit 5 provides the arbitrary person with both the name of a purchaser and reservation date that are obtained.

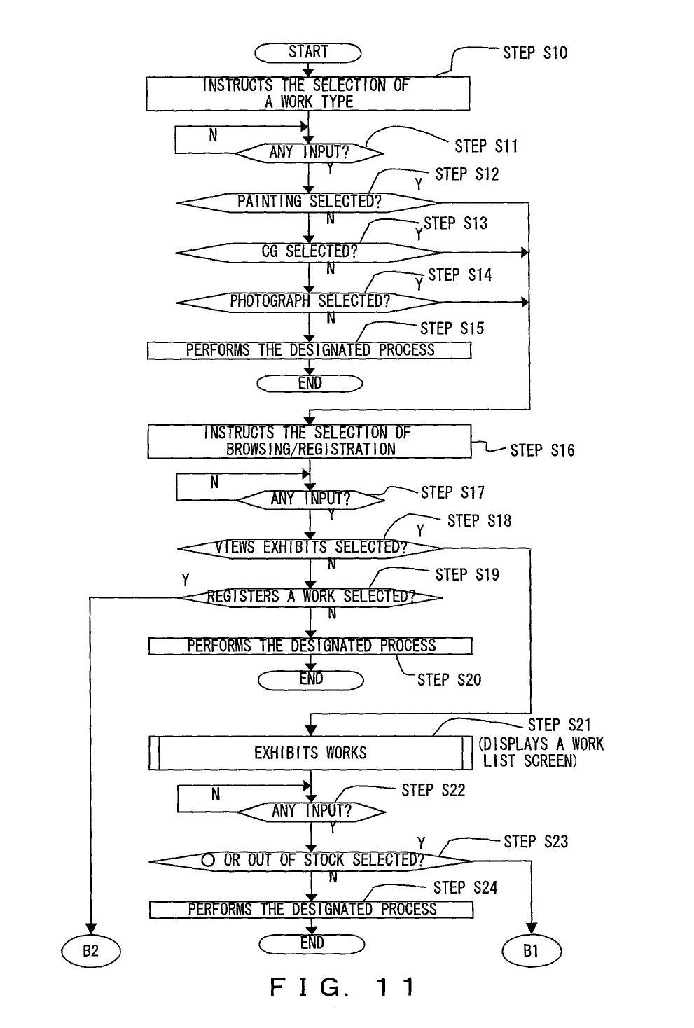

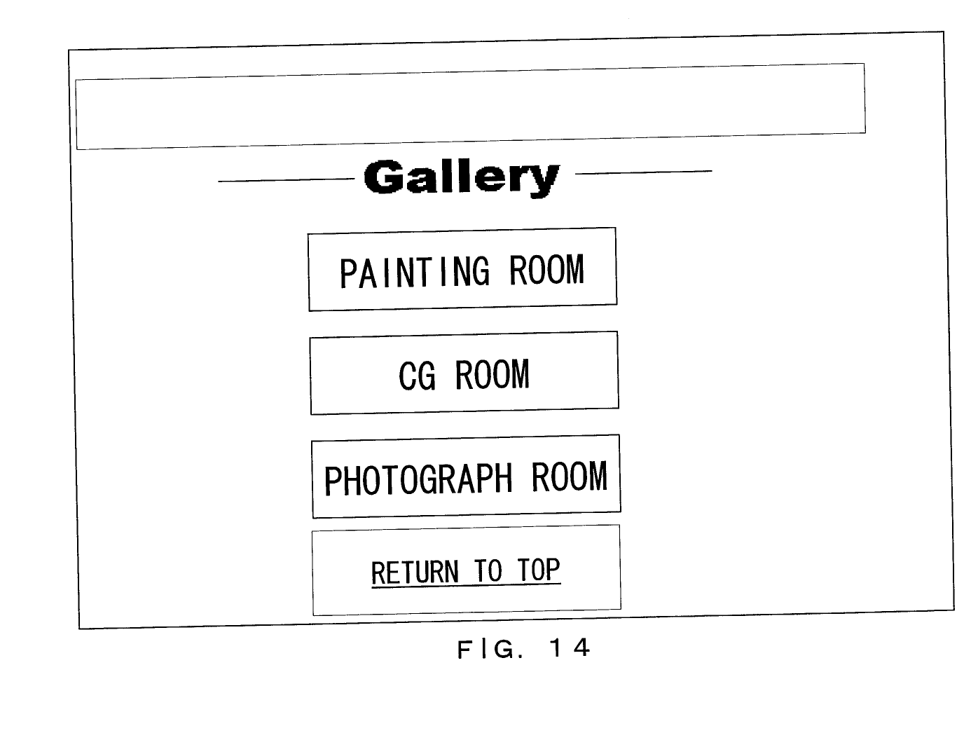

The basic process flow of the sale device 1 is described showing screen transitions from time to time with reference to both flowcharts shown in FIGS. 11 through 13 and display screens shown in FIGS. 14 through 21. In the following process, the description is given assuming that a GUI (Graphic User Interface) is used to input/output information. However, this present invention is not limited to this interface.

First, FIG. 11 is described. The sale device 1 instructs a person that accesses the sale device 1 via a network N (hereinafter called an “accessor”) to select the type of a work to be browsed or registered (step S10). FIG. 14 shows an example of a screen for selecting the type of a work to be browsed or registered (work type selection screen) that is displayed on the terminal TA or TB of the accessor. As shown in FIG. 14, there are several work types on the screen. The work types shown in FIG. 14 are simply examples, and the present invention is not limited to these work types.

The sale device 1 waits for the input of the accessor (step S11), and when the work type is selected (steps S12 through S14), the process proceeds to step S16. If another process is designated, the device 1 performs the designated process and terminates the process (step S15).

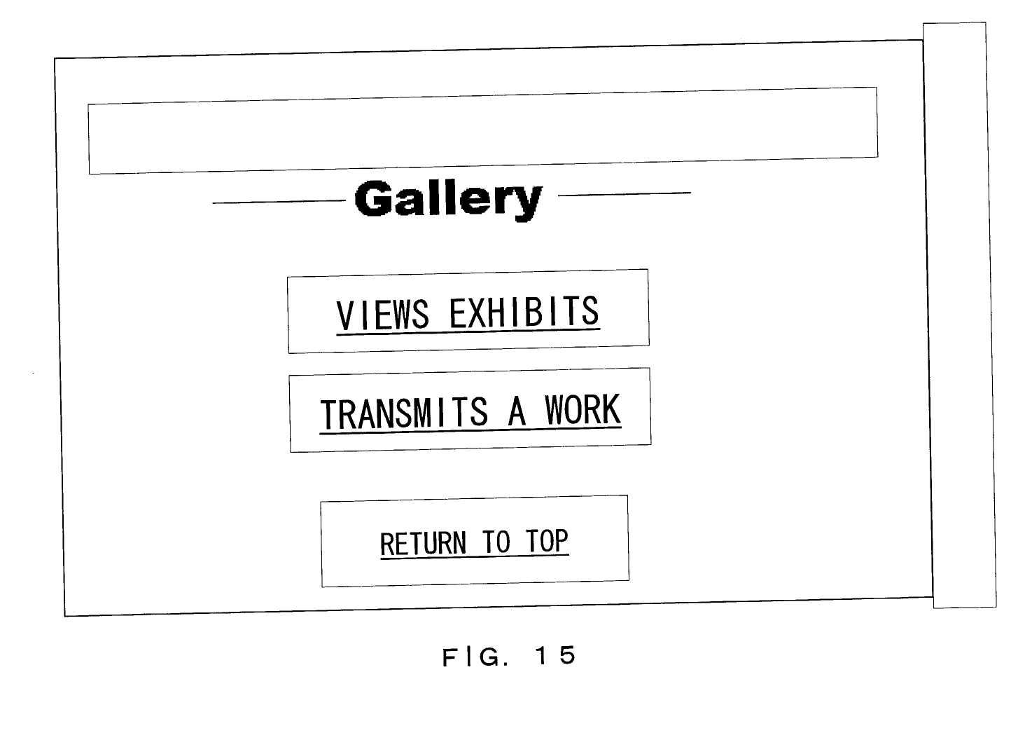

If the work type is selected, the sale device 1 instructs the accessor to select either the browsing or registration of a work (step S16) and waits for the input of the accessor (step S17). FIG. 15 shows an example of a screen for selecting either the browsing or registration of a work (browsing/registration selection screen) displayed on the terminal TA or TB of the accessor. In FIG. 15, the accessor selects “browse exhibits” and “transmit a work” in the case of browsing and registering a work, respectively.

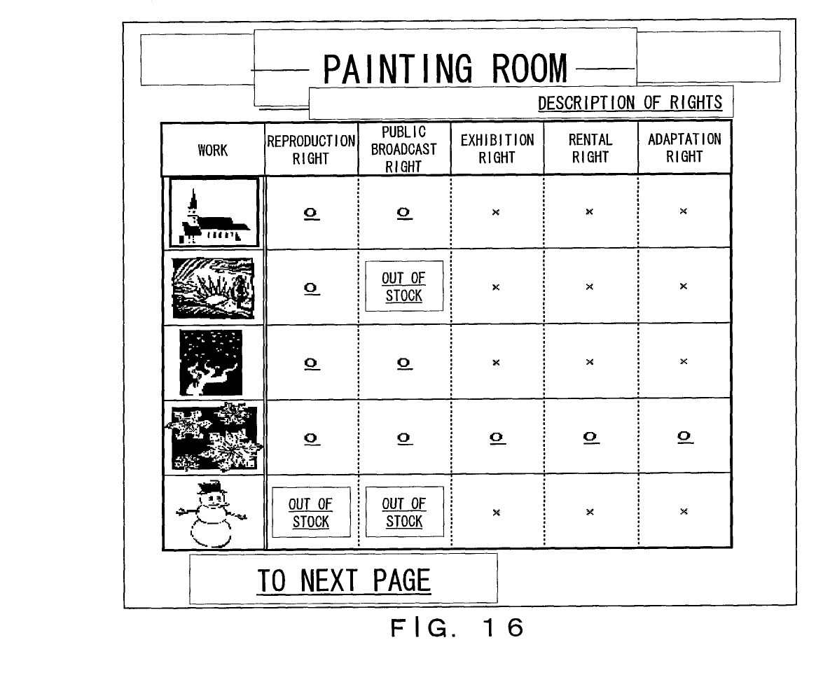

If in step S17 the “browsing of a work” is selected (Yes in step S18), the information provision unit 3 of the sale device 1 performs a process of exhibiting works (step S21). The detailed process in step S21 is described later. FIG. 16 shows an example of a screen for exhibiting works. In FIG. 16, both the samples (miniature images, etc.) of works and the types of rights that are sold in the sale device 1 are displayed. “◯”, “out of stock” and “x” in each column of the table indicate that the right of the work can be purchased, that the right of the work is out of stock and that the right of the work cannot be purchased, respectively.

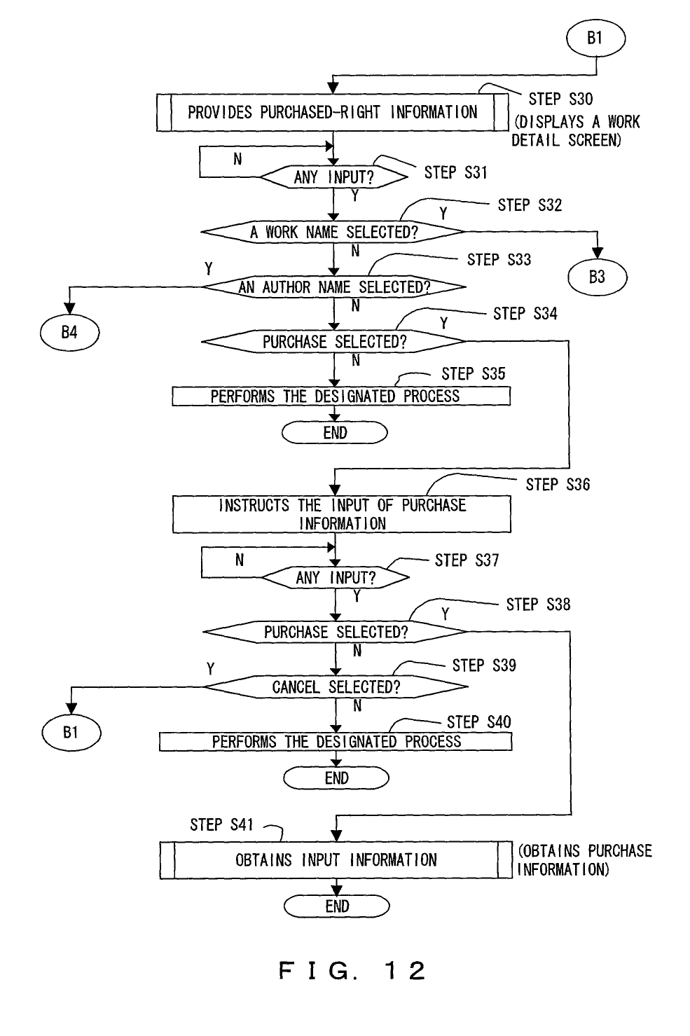

After exhibiting works, the sale device 1 waits for the subsequent input of the accessor (step S22) If the accessor selects one, the detailed information of which he/she wants, out of the works and rights that are exhibited (Yes in step S23), the process proceeds to branch B1, which is shown in FIG. 12. If another process is designated (No in step S23), the sale device 1 performs the designated process and terminates the process (step S24).

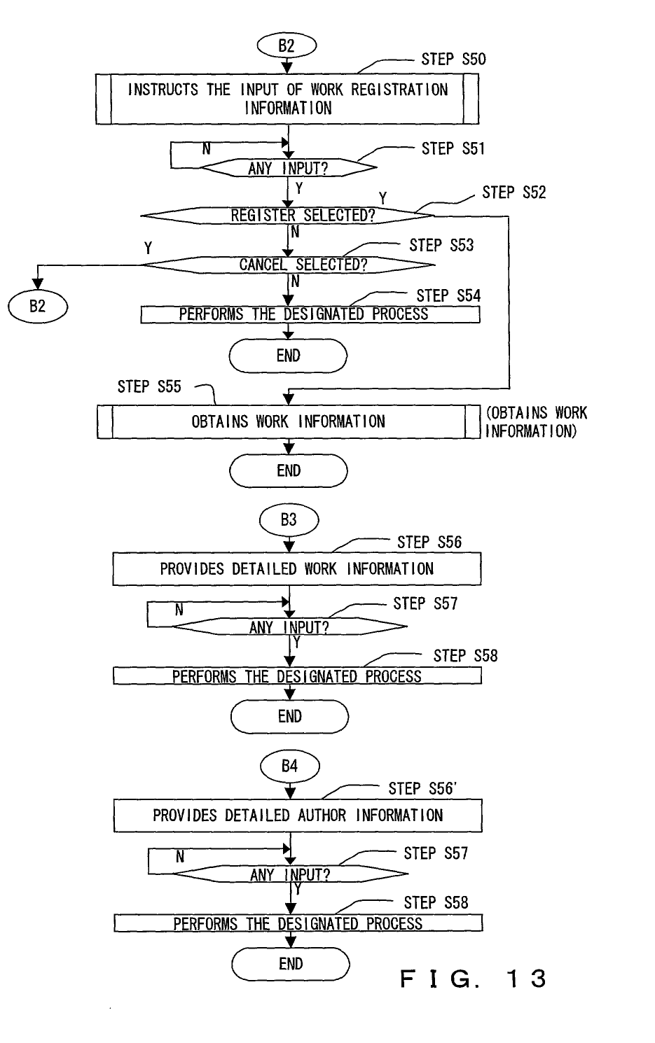

If in step S17 the “registration of a work” is selected (Yes in step S19), the process proceeds to branch B2, which is shown in FIG. 13. If another process than the browsing and registration of a work is selected (No in step S19), the sale device 1 performs the designated process and terminates the process (step S20).

The flow after branch B1 is described with reference to FIG. 12. When the process proceeds to branch B1, the information provision unit 3 of the sale device 1 performs a process of providing detailed information about the selected work and right (step S30) and waits for the input of the accessor (step S31). The process performed by the information provision unit 3 in step S30 is described in detail later.

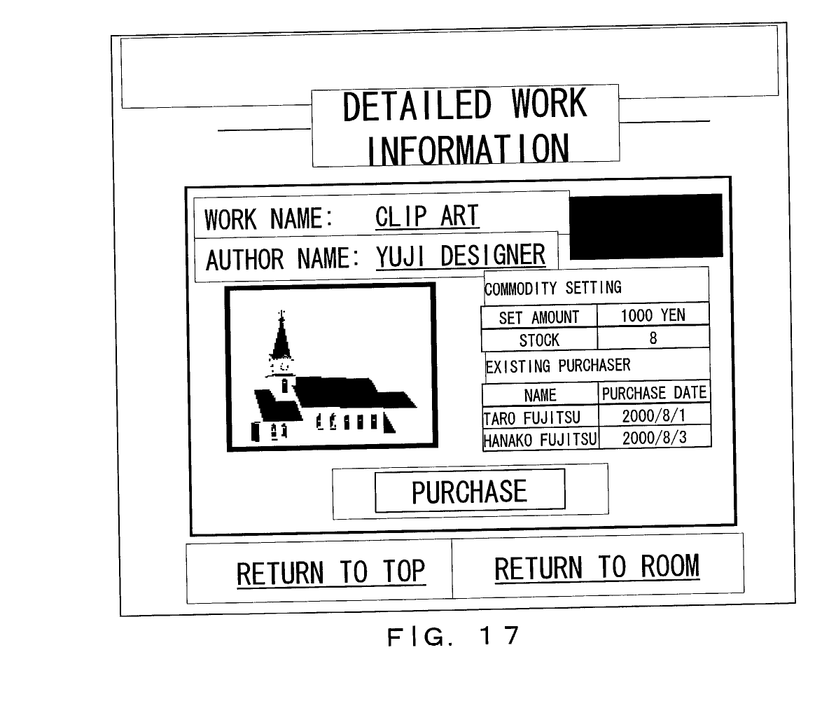

FIG. 17 shows one screen for providing detailed information about the selected work and right (purchased-right information screen). In FIG. 17, the work name and author name of the selected work, the samples of the work (or appearance of the work) and the type of the selected right, and the price, stock volume, existing purchaser names and purchase dates are displayed.

Since the information provision unit 3 publicizes information about a work and a right that are purchased, any one can obtain information about the existing purchaser of the right. Therefore, a seller can easily confirm both a purchaser and a purchased right. A purchaser can verify that he/she is the legal holder of a right and can easily confirm a right that he/she has purchased. An intentional copyright infringement can be suppressed.

In FIG. 17, since a work name and an author name are linked to the detailed information of a work and an author, respectively, an accessor can also obtain the information. If in FIG. 16 an accessor selects the right of a work marked with “◯” in a corresponding column (if a screen shown in FIG. 17 is displayed by clicking “◯”), a “purchase” button for moving to a purchase process is provided on the screen shown in FIG. 17. If an accessor selects the right of a work marked with “out of stock” in a corresponding column (if a screen shown in FIG. 17 is displayed by clicking “out of stock”), the “purchase” button is not displayed on the screen shown in FIG. 17.

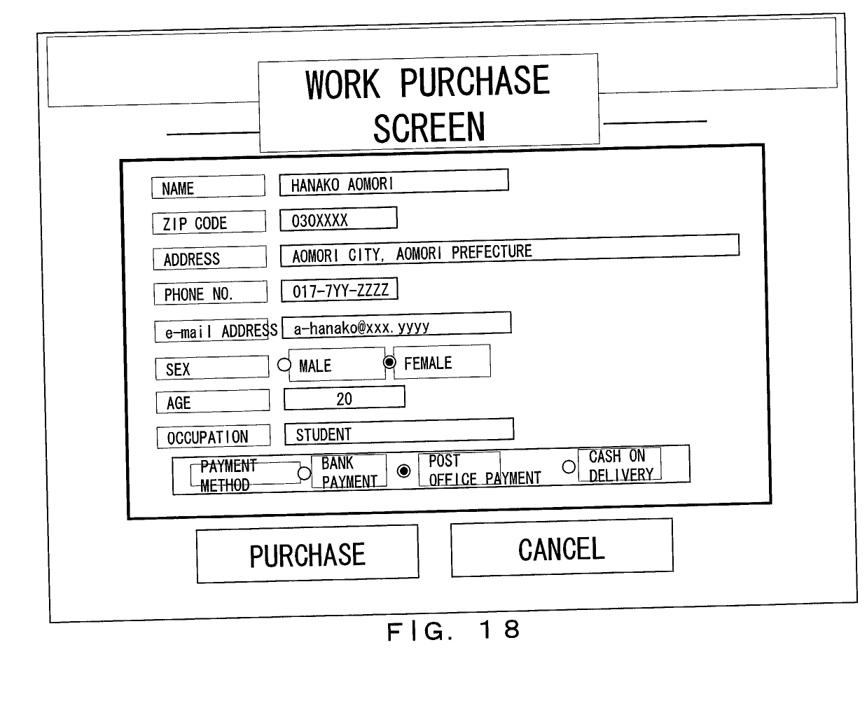

If in step S31 the accessor designates the provision of detailed work information (Yes in step S32), the process proceeds to branch B3, which is shown in FIG. 13. If the accessor designates the provision of detailed author information (Yes in step S33), the process proceeds to branch B4, which is also shown in FIG. 13. If the accessor designates the purchase process of a right (Yes in step S34), the process proceeds to step S36. If the accessor selects other processes than these (No in step s34), the process is terminated after the selected process is performed (step S35). If a purchase process is selected, the purchase information acquisition unit 7 instructs the accessor, which is also a purchaser, to input purchase information (step s36) and waits for the input of an accessor (step S37). FIG. 18 shows an example of a screen for inputting purchase information that is displayed on the terminal of an accessor. The accessor inputs purchase information according to instructions on the screen shown in FIG. 18 and confirms the inputted information. If the accessor wants to purchase, the accessor pushes the “purchase” button. If the accessor wants to cancel, the accessor pushes a “cancel” button.

If the accessor purchases (Yes in step S38), the purchase information acquisition unit 7 obtains the inputted purchase information (step S41). The detailed acquisition process of the purchase information is described later. If the accessor cancels purchase (Yes in step S39), the process proceeds to branch B1 and returns to step S30. If the accessor selects other processes than these (No in step S39), the sale device 1 performs the designated process and terminates the process (step S40).

The process flows after branches B2, B3 and B4 are described with reference to FIG. 13. If the process proceeds to branch B2, the work information acquisition unit 2 instructs the accessor, which is also a seller or an author, to input work information (step S50) and waits for the input of the accessor (step S51). The detailed process of instructing the input of registration information is described later.

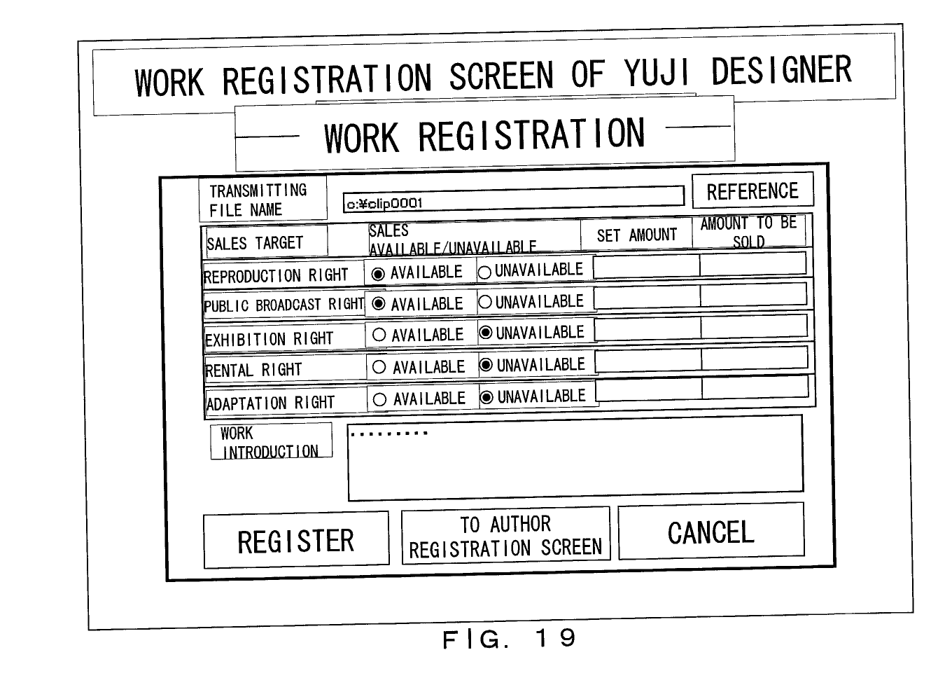

FIG. 19 shows an example of a screen for inputting work information to be displayed on the terminal of the accessor when the accessor registers a work (work registration screen). In FIG. 19, a work type of a work to be registered is assumed to be a painting. In FIG. 19, the screen is provided with a box for inputting the file name of an electronic painting (digital painting), a check column for selecting whether each right of the work to be sold is sold, a box for inputting the sale price (set amount) and sale volume (set volume) if the right is sold and a box for inputting information for introducing the work. The accessor inputs information according to the screen's instructions and pushes a “registration” button if the accessor registers. Alternatively, the accessor can register the work after further pushing a “To an author registration screen” button and inputting information about the author. If the accessor stops the registration, the accessor pushes a “cancel” button.

In the work registration screen shown in FIG. 19, rights can be sold corresponding to a work type are shown. For example, if a work type of a work to be sold is a painting, a reproduction right, a public broadcast right, an exhibition right, a rental right and a translation/adaptation right are displayed as rights that can be sold because these rights are based on a copyright for a painting. In this way, even if the accessor (seller) does not well understand a copyright, a right that cannot be sold can be prevented from being sold by mistake.

If in step S51 the accessor selects registration (Yes in step S52), the work information acquisition unit 2 obtains the inputted work information (step S55). The detailed process of obtaining the work information is described later. If in step S51 the accessor selects cancellation (Yes in step S53), the process proceeds to branch B2. If the accessor designates other processes than these (No in step S53), the designated process is performed and the process is terminated (step S54).

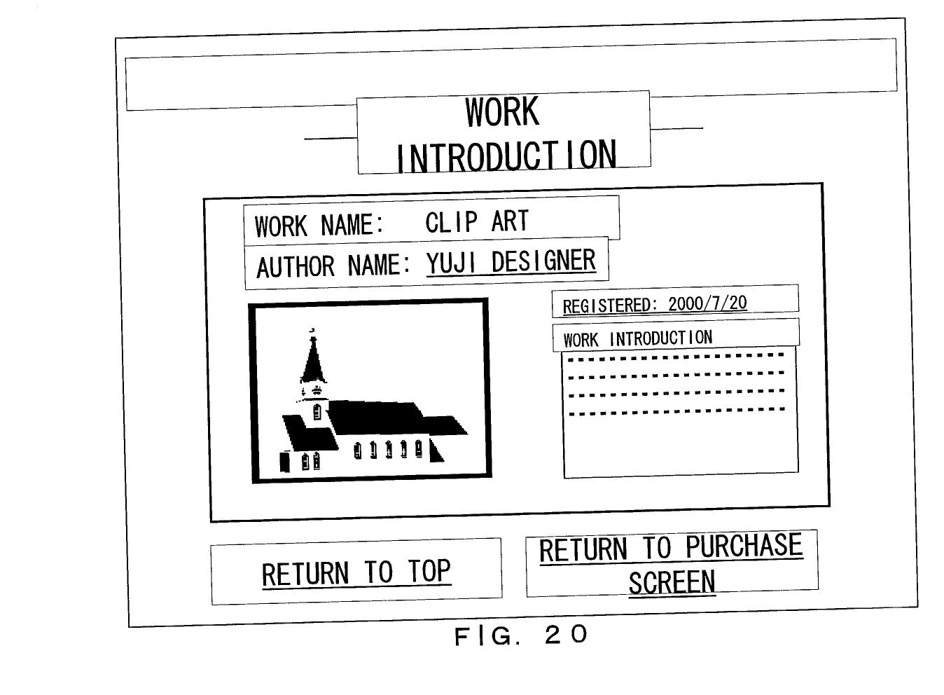

If the process proceeds to branch B3 in FIG. 12, the work information provision unit 4 of the information provision unit 3 obtains work introduction information from the work information corresponding to the selected work by referring to the work master 14 using a work code corresponding to the selected work, provides the accessor with the information (step S56) and waits for the input of the accessor (step S57). FIG. 20 shows an example of a screen for providing detailed work information. Although the screen shown in FIG. 20 is almost the same as the purchased-right information screen shown in FIG. 17, in FIG. 20 work introduction information is displayed instead of information about both commodity setting and existing purchasers. If the accessor inputs (Yes in step S57), the designated process is performed and the process is terminated (step S58).

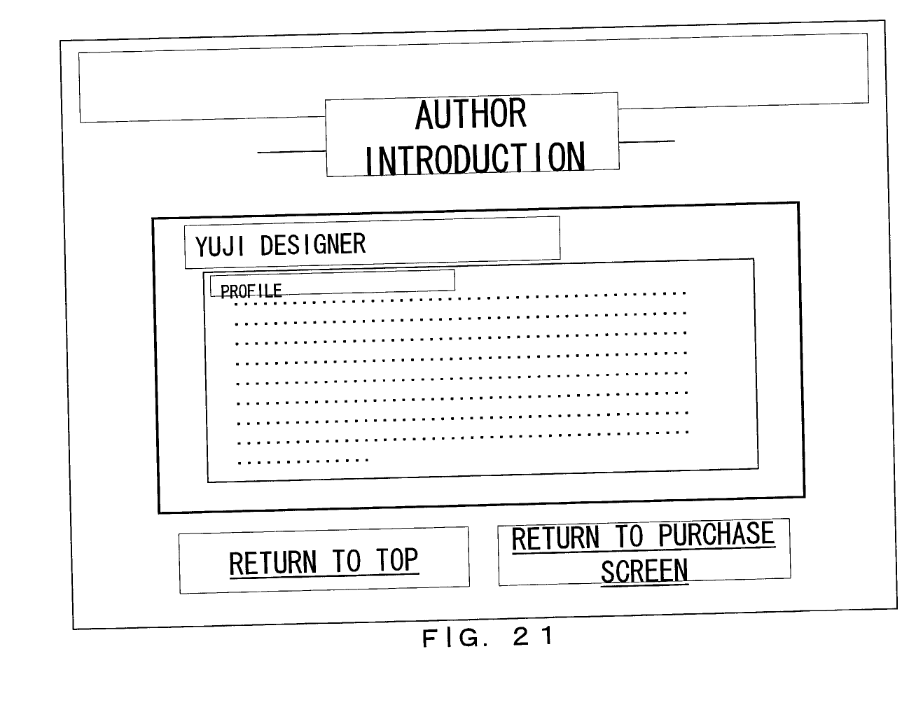

If the process proceeds to branch B4 shown in FIG. 12, the similar process performed when the process proceeds to branch B3 is performed. The difference is that in the case of branch B3, in step S56 the work master 14 is referenced using a work code, whereas in the case of branch B4, the author master 13 is referenced using an author code and as a result, a profile (self introduction) is obtained from author information corresponding to the selected author and is provided to the accessor (step S56′). After step S56′, steps S57 and S58 are performed as in the case of branch B3. FIG. 21 shows an example of a screen for providing detailed author information.

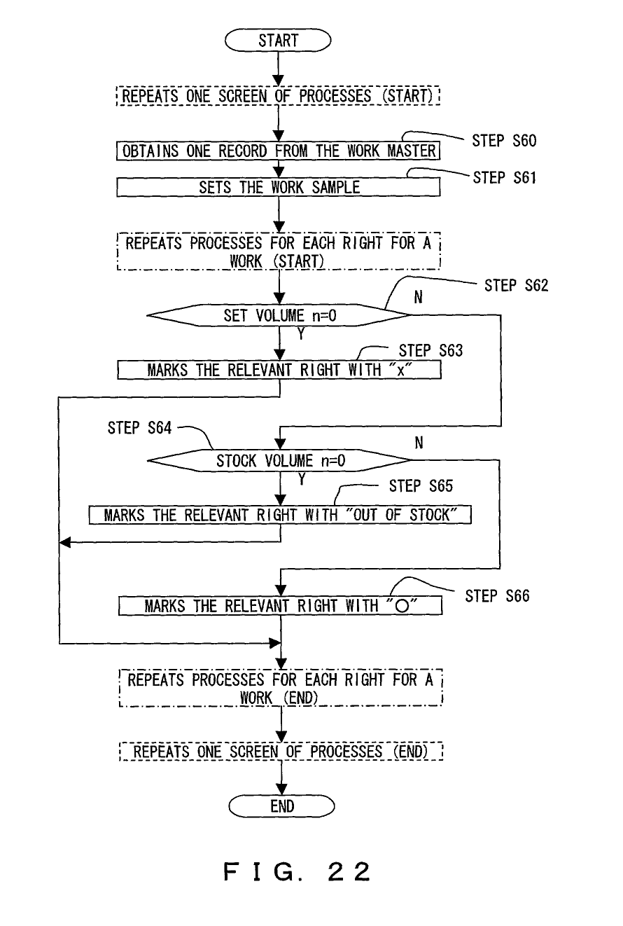

Each process is described in detail below. In step S22 of FIG. 11, the information provision unit 3 displays a list of works and the rights to be sold in the sale device 1 using the work list screen shown in FIG. 16. The work list screen display process in step S21 of FIG. 11 is described in detail with reference to FIG. 22. In FIG. 22, processes between two dashed rectangles are performed for each screen. Specifically, the maximum number of works to be displayed on one screen is predetermined and the processes are repeated by times obtained by dividing the total number of works by the maximum number of works displayed on one screen (in case it cannot be divided, 1 is added).

The work information provision unit 4 of the information provision unit 3 refers to the work master 14 using a type code corresponding to the selected work type in steps 12 through 14 of FIG. 11, and obtains the work information corresponding to the selected work type (step S60). For example, if in step S12 painting is selected, the work information provision unit 4 refers to the work master 14 using a type code corresponding to painting. The work information provision unit 4 generates work samples using file names included the obtained work information and sets samples on a screen (step S61). Processes between two one-point-chained rectangles are performed for each right of each work. The work information provision unit 4 first judges whether the set volume for a right code included in a piece of work information is 0(zero) (step S62). If the set volume is 0 (zero) (Yes in step S62), the work information provision unit 4 sets “x” indicating that the sale is unavailable in a column corresponding to the right code on the screen (step S63), and the process returns to step S62 to perform the process for another right code.

If the set volume is not 0 (zero) (No in step S62), the work information provision unit 4 further judges whether the stock volume for the right code is 0 (zero) (step S64). If the stock volume is 0 (zero) (Yes in step S64), the work information provision unit 4 sets “out of stock” in a column corresponding to the right code on the screen (step S65), and the process returns to step S62 to perform the process for another right code. If the stock volume is not 0 (zero), the work information provision unit 4 sets “◯” indicating that the sale of the right is available in a column corresponding to the right code on the screen (step S65), and the process returns to step S62 to perform the process for another right code.

After performing steps S62 through S66 for all the rights of a work, the work information provision unit 4 performs the same process for another work. In this way, the work information provision unit 4 provides the accessor with information about works and the rights to be sold.

In the purchased-right information provision process in step S30 of FIG. 12, the information provision unit 3 provides the purchased-right information of a work and rights selected by the accessor on the purchased-right information screen shown in FIG. 17. The process in step S30 of FIG. 12 is described in detail.

First, the work information provision unit 4 of the information provision unit 3 obtains both a work code and right code corresponding to the work and right, respectively, selected instep S23 of FIG. 11. The work information acquisition unit 4 obtains work information corresponding to the selected work by referring to the work master 14 using the work code (step S70), obtains a work name, an author name and a work file name from the obtained work information and generates a work sample based on the work file. Furthermore, the work information provision unit 4 obtains a set volume, a sale amount and a stock volume corresponding to the selected right, from the work information using the right code. The work information provision unit 4 sets the work name, the author name, the work sample, the set volume, the sale amount and the stock volume on the screen together with the right name (step S71).

Processes in steps S72 through S74 are repeated for each piece of purchase information corresponding to the right of a work. The purchased-right information provision unit 5 refers to the purchase information file 15 using both the work code and the right code and obtains one piece of the purchase information of a purchaser that has purchased the right of the selected work (step S72). The purchased-right information provision unit 5 judges whether a payment flag in the obtained purchase information is on (step S73).

If the flag is on (Yes in step S73), the purchased-right information unit 5 sets both a purchaser name and a reservation date (purchase date) included in the purchase information, on the screen (step S74) and the process returns to step S72 to perform the same process for another piece of purchase information. If the flag is not on (No in step S73), the process returns to step S72 without performing step S74, and the purchased-right information provision unit 5 performs the same process for another piece of purchase information.

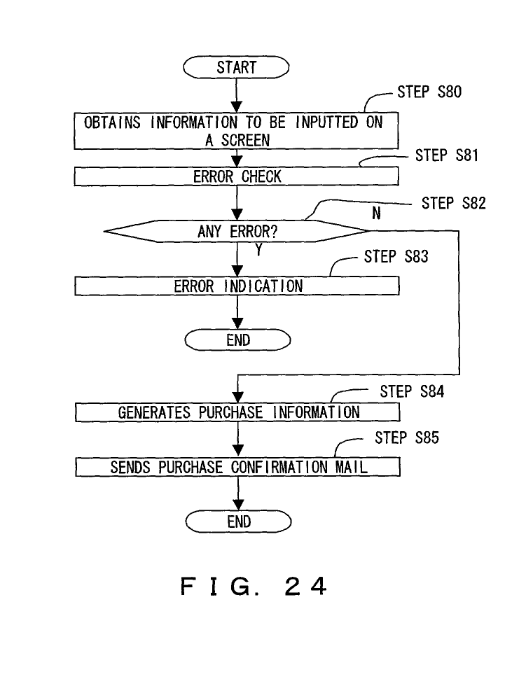

In the purchase information acquisition process in step S41 of FIG. 12, the purchase information acquisition unit 7 obtains purchase information from a purchaser. The process in step S41 of FIG. 12 is described in detail with reference to FIG. 24.

First, the purchase information acquisition unit 7 obtains information that a purchaser inputs on the purchase screen shown in FIG. 18 (step S80). The purchase information acquisition unit 7 detects an error in the obtained information (step S81). For example, the omission of a necessary item, etc., is detected. If there is an error (Yes in step S82), the purchase information acquisition unit 7 notifies the purchaser of the error in the inputted information (step S83) and terminates the process. If there is no error (No in step S82), the purchase information acquisition unit 7 generates purchase information based on the inputted information and stores the information in the purchase information file 15 (step S84). The purchase information acquisition unit 7 confirms the purchase using an e-mail address (or phone number, etc.) inputted by the purchaser (step S85) and terminates the process.

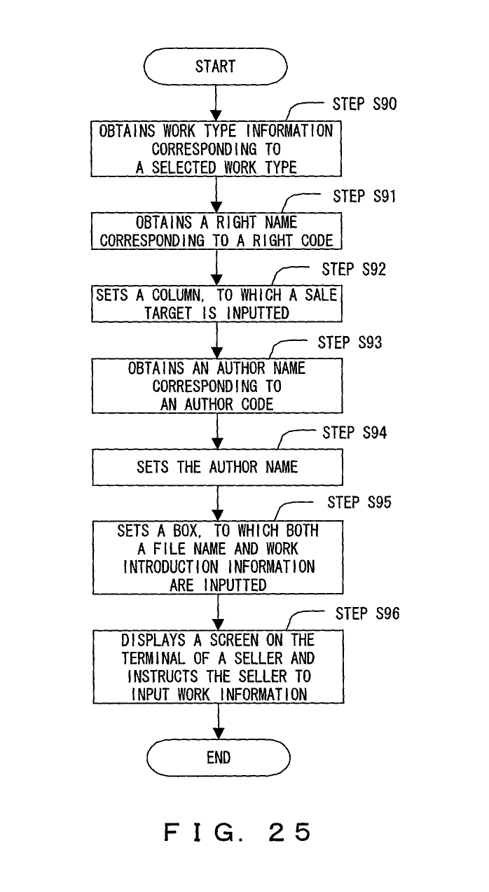

In the work registration information input instruction process in step S50 of FIG. 13, the work information acquisition unit 2 instructs the accessor (seller) to input work information. The process in step S50 of FIG. 13 using the work registration screen shown in FIG. 19 is described in detail with reference to FIG. 25.

Before proceeding to branch B2, in steps S12 through S14 of FIG. 11, the seller selects a work type. The work information acquisition unit 2 obtains work type information corresponding to the selected work type by referring to the work type table 11 using a type code corresponding to the selected work type (step S90) and further obtains a right name corresponding to each right code from the right table 12 (step S91).

Work type information indicates rights based on a copyright corresponding to a work type. The work information acquisition unit 2 sets columns for inputting the sale availability/unavailability, set volume and sale amount, if available, of each right can be sold on the screen (work registration screen shown in FIG. 19) (step S92). In the work type information, rights can be sold for the work type are indicated by setting their right flags on (1). In this way, a seller can be prevented from setting a right that cannot be sold as a right to be sold.

The work information acquisition unit 2 also instructs the seller to input an author code, which can be instructed at earlier timing, refers to the author master 13 using the inputted author code and obtains an author name from the author information corresponding to the author code (step S93). The work information acquisition unit 2 sets the author name on the screen (step S94). A seller can be prevented from registering a work as another person's work by mistake by confirming the author name, which in many cases is an author.

Furthermore, the work information acquisition unit 2 sets a box for inputting both the file name and work introduction information of the work (step S95). The work information acquisition unit 2 displays the generated screen on the terminal TB of the seller, instructs the seller to input work information (step S96) and terminates the process.

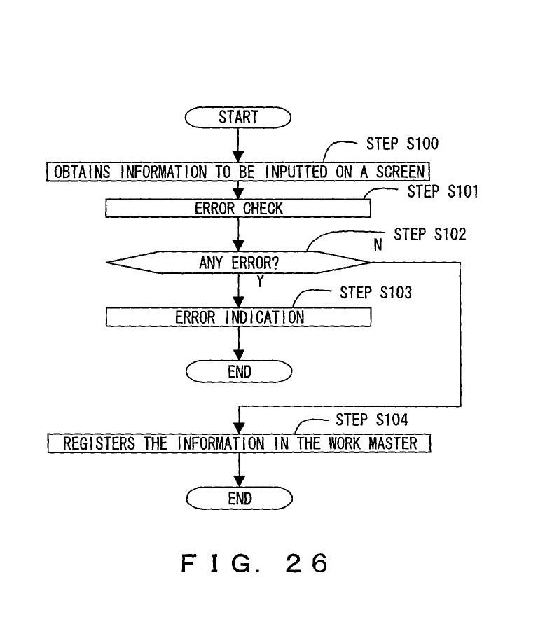

In the work information acquisition process in step S55 of FIG. 13, the work information acquisition unit 2 obtains work information from a seller. The process in step S55 of FIG. 13 is described in detail with reference to FIG. 26.

First, the work information acquisition unit 2 obtains information that the seller inputs on the work registration screen shown in FIG. 19 (step S100). The work information acquisition unit 2 detects an error in the obtained information (step S101). If there is an error (Yes step S102), the work information acquisition unit 2 notifies the seller of the error in the inputted information (step S103) and terminates the process. If there is no error (No in step S102), the work information acquisition unit 2 generates work information based on the inputted information, stores the information in the work master 14 (step S104) and terminates the process.

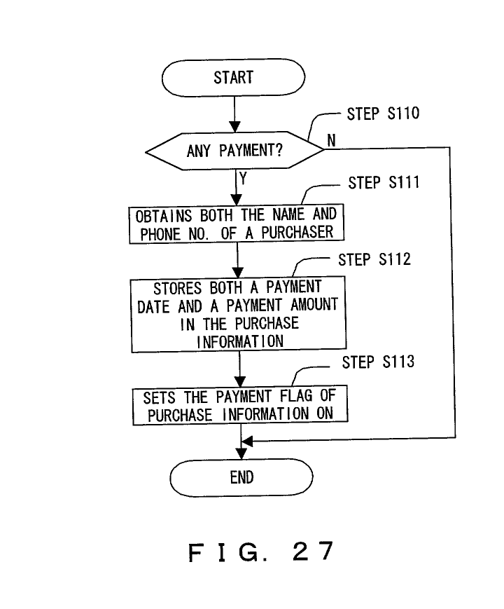

Lastly, a process of confirming payment and setting a payment flag is described with reference to FIG. 27. This process is basically performed every day. First, the payment confirmation unit 6 judges whether there is payment in a prescribed financial institute (step S110). If there is no payment (No in step S110), the payment confirmation unit 6 terminates the process. If there is payment (Yes in step S110), the payment confirmation unit 6 obtains both a payment amount and a name and/or phone number of the payer, that is, a purchaser (step S111). Both the name and phone number of a payer as well as the amount are usually reported from the financial institute when there is payment.

The payment confirmation unit 6 refers to the purchase information file 15 using the name and/or phone number of the payer, obtains purchase information corresponding to the purchaser, stores both a payment date (current date) and a payment amount in the obtained purchase information (step S112), sets the payment flag on (1) (step S113) and terminates the process. A part of purchase information, the payment flag of which is on, is publicized on a purchased-right information screen after that time.

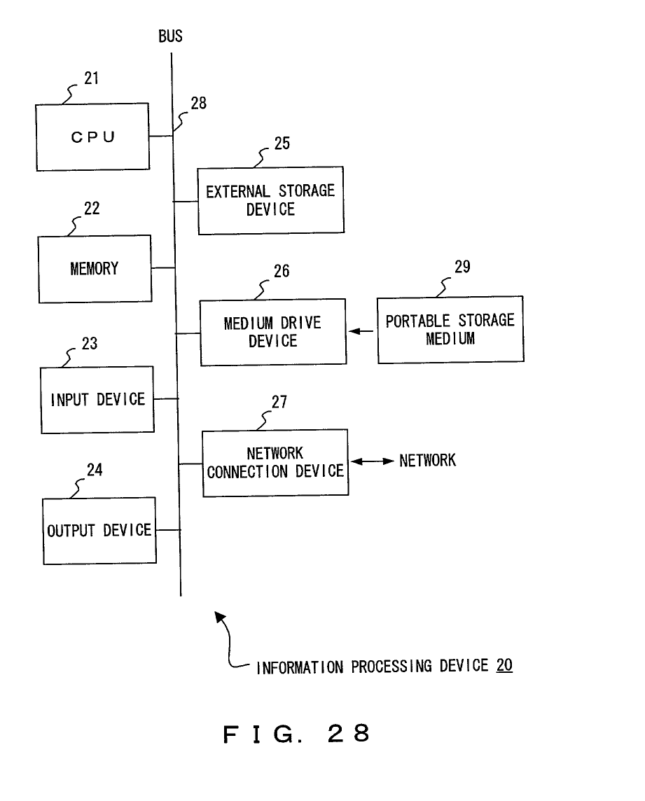

The terminals TA and TB and sale device 1, which are described in the preferred embodiments, can be configured using an information processing device (computer) as shown in FIG. 28. The information processing device 20 shown in FIG. 28 comprises a CPU 21, a memory 22, an input device 23, an output device 24, an external storage device 25, a medium drive device 26 and a network connection device 27, and the devices are connected to one another by a bus 28.

The memory 22 includes, for example, a ROM (Read-Only Memory), aRAM (Random-Access Memory), etc., and stores both programs and data used for the process. The CPU 21 performs necessary processes by using the memory 22 and executing the programs and data.

Each device composing the sale device 1 and terminals TA and TB of the preferred embodiment is stored in the specific respective program code segment of the memory 22 as a program. The input device 23 is, for example, a keyboard, a pointing device, a touch panel, etc., and is used to input the instructions and information from a user. The output device 24 is, for example, a display, a printer, etc., and is used to output inquiries, process results, etc., to a user from the information processing device 20.

The external storage device 25 includes, for example, a magnetic disk device, an optical disk device, a magneto-optical disk device, etc. The programs and data described above can also be stored in this external storage device 25 and can be used by loading them into the memory 22, as requested.

The medium drive device 26 drives a portable storage medium 29 and accesses the recorded contents. For the portable storage medium 29, an arbitrary computer-readable storage medium, such as a memory card, a memory stick, a floppy disk, a CD-ROM (Compact Disc Read-Only Memory), an optical memory, a magneto-optical disk, a DVD (Digital Versatile Disk), etc., are used. The programs and data can also be stored in this portable storage medium 29, and can be used by loading them into the memory 22, as requested.

The network connection device 27 communicates with an outside device via an arbitrary network N (line), such as a LAN, WAN, etc., and transmits/receives data accompanying the communications to/from the outside. The programs and data can also be received from an outside device, as requested, and can be used by loading them into the memory 22.

FIG. 29 shows both the computer-readable storage medium and transmission signal for providing the information processing device 20 shown in FIG. 28 with the programs and data.

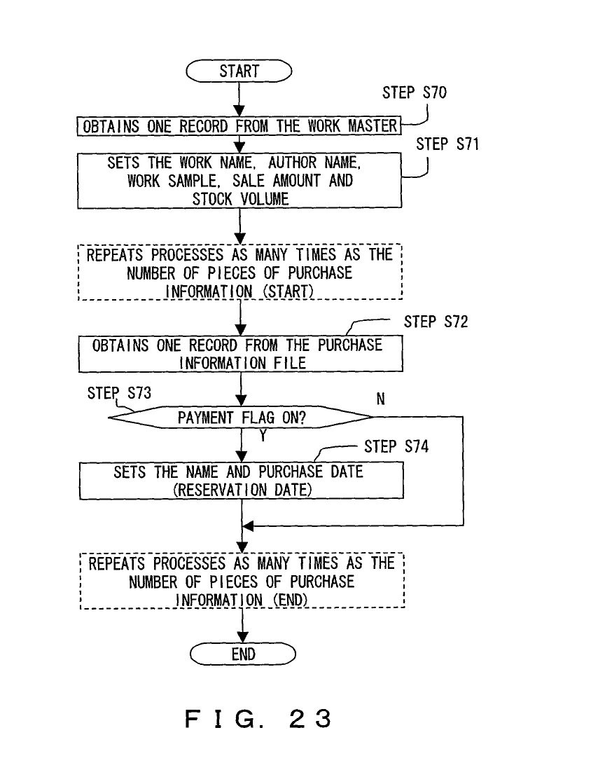

A general-purpose computer can also implement the function equivalent to the sale device 1 described in the preferred embodiment. That is, it is sufficient if it is configured so that a program for enabling a computer to perform the same process as that performed by the sale device 1 in the flowcharts shown in FIGS. 11 through 13 and 22 through 27 described in the preferred embodiment can be stored in advance in a computer-readable storage medium 29 and as shown in FIG. 29, the program can be read and temporarily stored from the storage medium into the memory 22 or external storage device 25 by the computer 20, and the stored program can be read and executed by the CPU 21 of the computer 20.

A transmission signal that is transmitted via a line 31 (transmission medium) when the program is downloaded from a program (data) provider 30 to the computer 20, can also be read by a general-purpose computer with the function equivalent to the sale device 1 described in the preferred embodiment of the present invention described above.

Although the preferred embodiments of the present invention are described above, the present invention is not limited to those preferred embodiments, and a variety of modifications and changes can also be made.

For example, although in the preferred embodiment, sometimes an electronic literary work is used as an example, the present invention is also applicable to a non-electronic literary work.

For example, the sale device can further comprise a verification document issuance unit for issuing a document for authenticating the purchased right of a purchaser. This document can be a printed document or document data. In the case of document data, the data can also be provided with electronic transparency.

For example, if a literary work sold by the sale device is an electronic literary work, the sale device can also further comprise a verification information addition unit for attaching information for authenticating a purchaser to a literary work. In this case, for the information for authenticating a purchaser, for example, electronic transparency, including the name of a purchaser, etc., can be used.

Each unit and database composing the sale device 1 implements a series of business processes by operating in cooperation with one another. Each unit and database can be provided in the same server. Alternatively, each unit and database can be provided in different servers and can be operated in cooperation with another via a network.

As described above, according to the present invention, it can be clarified who possesses what right of what literary work by selling literary works per units of rights and by providing information about a purchased right. Therefore, intentional copyright infringement of a person can be suppressed and a purchaser that does not well understand a copyright can be prevented from unintentionally infringing a copyright while selling literary works.

While the invention has been described with reference to the preferred embodiments thereof, various modifications and changes may be made by those skilled in the art without departing from the true spirit and scope of the invention as defined by the claims thereof.

What is claimed is:

1. A sales method for selling a literary work, comprising:
selling the literary work; and
providing information about a purchaser that has purchased the literary work via a network.

2. The sales method according to claim 1, wherein the literary work is sold per units of rights based on a copyright of the literary work.

3. The sales method according to claim 2, wherein the information about the purchaser is provided per units of the sold rights.

4. The sales method according to claim 2, further comprising:
notifying a seller of the literary work of rights based on the copyright corresponding to a type of the literary work; and
obtaining from the seller information about the right to be sold, from the notified rights.

5. The sales method according to claim 1, wherein the information about the purchaser is provided to an arbitrary person.

6. The sales method according to claim 1, wherein the information about the purchaser is provided after payment of a purchase price is confirmed.

7. A purchase method for purchasing a literary work, comprising:
purchasing the literary work; and
being authenticated to be a purchaser of the literary work by publicizing the fact via a network.

8. A consignment sales method for consigning sale of a literary work, comprising:
consigning sale of the literary work per units of rights based on a copyright; and
receiving information about a purchaser that has purchased the right.

9. A computer-readable storage medium for recording a program for enabling a computer to control the sale of a literary work, said program to make the computer perform the process comprising:
selling the literary work; and
providing information about a purchaser that has purchased the literary work, via a network.

10. A sale device which is connected to a network and sells a literary work, comprising:
purchase information acquisition means for obtaining information about a purchaser that has purchased the literary work; and
information provision means for providing the information about the purchaser via the network.

11. A sale device which is connected to a network and sells a literary work, comprising:
a purchase information acquisition unit obtaining information about a purchaser that has purchased the literary work; and
an information provision unit providing the information about the purchaser via the network.

12. A computer data signal embodied in a carrier wave and representing a program for enabling a computer to control the sale of a literary work, said program to make the computer perform the process of:
selling the literary work; and
providing information about a purchaser that has purchased the literary work, via a network.

13. A transmission medium for implementing a computer program for enabling a computer to control the sale of a literary work, said program to make the computer to perform the process of:
selling the literary work; and
providing information about a purchaser that has purchased the literary work, via a network.
